(19) United States
(12) Patent Application Publication
(10) Pub. No.: US 2008/0134849 A1
(43) Pub. Date: Jun. 12, 2008

(54) System and method for making U.S. banknotes readable by visually-impaired persons

(76) Inventor: Charles B. McGough, Savannah, GA (US)

Correspondence Address: CHARLES B. McGOUGH, 3 MARSHBRIDGE LANE, SAVANNAH, GA, 31411, US

(21) Appl. No.: 11/650,780

(22) Filed: Jan. 9, 2007

Related U.S. Application Data
(60) Provisional application No. 60/873,373, filed on Dec. 8, 2006.

(51) Int. Cl. B26D 3/00

(52) U.S. Cl. 83/13

(57) ABSTRACT

This invention is a simple system and method for making U.S. banknotes easily readable by all visually-impaired persons, without requiring major changes to the way U.S. currency is now produced, nor the replacement of millions of existing vending, ATM, and currency counting machines. The system slightly modifies the six lowest-denomination U.S. banknotes, $1 through $50, by truncating a small section from different corners of each denomination. This enables a visually-impaired person to hold the banknote in any orientation and determine by feel its correct denomination. The specific sequence of truncated corners has been designed so that no banknote can be altered by truncating additional corners to make it feel like a higher-value banknote to a visually-impaired person. The invention eliminates all problems created by systems using embossed or embedded characters, different-size denominations, hand-held currency reading devices, and other systems which have been proposed for assisting visually-impaired persons to read currency.

### CROSS REFERENCE TO RELATED APPLICATIONS

This application claims priority to, and the benefits of, U.S. Provisional Patent Application Ser. No. 60/873,373, filed on Dec. 1, 2006.

### STATEMENT REGARDING FEDERALLY SPONSORED RESEARCH & DEVELOPMENT

Not Applicable

### REFERENCE TO SEQUENCE LISTING

Not Applicable

### BACKGROUND OF THE INVENTION

1. Field of Endeavor

The field of endeavor of this invention is Printed Matter/Banking (Class 283/57), specifically currency banknotes.

2. Description of Prior Art

Literally dozens of U.S. and foreign patents describe various methods of making currency banknotes readable by blind or visually-impaired persons, so that such persons can differentiate between banknotes of various denominations without assistance. Most of these patents employ some type of embossed tactile characters on the notes (e.g. braille-type characters) so that blind persons may detect the different denominations by feel. Other patents describe various electronic devices which visually-impaired individuals could use to read paper currency denominations. The use of different size notes for each denomination has also been proposed, as are now used in many foreign currencies including the Euro.

In U.S. Pat. No. 6,277,572, March 1999, Lyen teaches the use of tactile indicia placed on currency to assist visually-impaired persons to identify denominations.

In U.S. Application 20040008871, January 2004, Smith describes another method for using tactile characters embossed into the currency to allow its denomination to be read by touch.

Reinart, in U.S. Application 20060119096, June 2006, proposes the use of currency notes having surface regions of differing sizes, configurations, or covered openings (windows) to allow identification of denominations by human touch.

In Publication Number GB2316909, March 1998, Pond and Stephenson describe the use of embossed identifiers in banknotes for the visually-impaired.

In U.S. Pat. No. 6,176,522, January 2001, Jackson uses a section of transparent plastic material in the banknote, which includes a security device with embossed lines which are detectable by touch.

In U.S. Pat. No. 5,636,565, June 1997, Laurance teaches an embossing method and device for braille currency encoding.

Many other U.S. patents teach a variety of methods of applying raised or embossed numbers, letters, or characters to the faces of notes, documents, labels, or other surfaces to enable visually-impaired persons to read them.

In addition to the numerous proposals, some described above, for designing features into banknotes to make them readable by the visually-impaired, there are many patented devices and machines (cf. Classes 434/112; 382/114; 382/135) which are also intended to help the visually-impaired distinguish the denominations of currency. These machines and devices, because they are so fundamentally different from the solution described in this application, are not considered to be applicable prior art.

All of the methods patented or applied for to date for enabling visually-impaired persons to read banknote denominations, either by embossing or modifying the currency itself, or by using a machine or device to read the banknotes, or by a combination of both, have one or more serious shortcomings when applied to the U.S. currency system.

These shortcomings are:

1. Embossed banknotes, or different-sized banknotes, or banknotes containing holes, windows, embedded strips, etc. would not work in current ATM, bank counting, or retail vending machines, and would require the expensive replacement of millions of such machines now in use in the U.S.

2. Banknotes containing embossed braille symbols would not be useful to the millions of functionally-blind persons in the U.S. who do not read braille.

3. Raised or embossed characters on banknotes would wear down quickly in normal use and shorten substantially the useful life of the banknote.

4. Adding embossed characters, windows, or other similar reading aids to current U.S. banknotes would force drastic changes to the present U.S. banknote printing process, would probably negate the new anti-counterfeiting features recently added to U.S. currency, and thus would be enormously expensive to the U.S. taxpayers.

5. Requiring millions of visually-impaired persons to purchase hand-held currency reading devices would be expensive and impractical.

For these reasons none of the many patents or patent applications now on record offer a workable, cost-effective means of making U.S. banknotes readable to blind or visually-impaired persons and, therefore, they will probably never be adopted by the U.S. Treasury Department.

Applicant has also conducted a NexisLexis search of hundreds of documents relating to paper currency for blind or visually-impaired persons, to determine if any of these published documents offer solutions not previously patented. Although the literature is full of articles on this subject, applicant has found none which offer new solutions, and no method has been adopted as a world-wide standard.

An example of such a document is the study conducted by the Bank of Canada (cf. Using Tactile Features to Help Functionally Blind Individuals Denominate Banknotes, Human Factors, No. 3, Vol. 44, p. 413, Sep. 22, 2002). This very extensive research project explored the feasibility of using a raised texture feature consisting of a local pattern of raised dots on the banknotes.

Another report, by the U.S. National Research Council in 1995, surveyed the currencies of 171 countries. The report listed a total of eight features which, singly or in some combinations, might assist visually-impaired users to differentiate among banknote denominations. These features were: variable size banknotes, large numerals, variable colors, specially shaped patterns, specific engraved visible markings, specific engraved invisible markings, watermark features, and machine-identifiable features. The report notes that none of these methods have been adopted as a worldwide standard, and none are in use in U.S. currency today.

In summary, neither the patent search nor the extensive NexisLexis search of documents in the public domain have uncovered any systems or methods for making U.S. currency readable by the visually-impaired which are similar to, or have anticipated, the system and method described in this application.

### BRIEF SUMMARY OF THE INVENTION

The object of this invention is to create a U.S. currency system in which the denominations of banknotes used in normal retail commerce can be clearly and easily readable by all visually-impaired persons, without requiring any assistance by a sighted person nor any device or instrument. The system requires only very minor changes to the way U.S. currency is now printed, and no replacement of the millions of existing ATM, vending, and currency counting systems in use throughout the country.

The method employs a unique system of banknotes with one or more of their corners truncated (clipped) in a specific progression, from $1 through $50, so that a visually-impaired person can hold the banknotes and easily determine their values by simply feeling the number and specific location of their clipped corners.

The sequence of banknotes shall have fewer corners clipped as the denominations progressively increase from $1 through $50 so that a counterfeiter cannot defraud a visually-impaired person by clipping additional corners off of a banknote.

The system and method disclosed herein is simple, foolproof, inexpensive to implement, and easily useable by all visually-impaired persons. It eliminates all of the problems which would be created by the many other solutions which have been proposed to aid blind and visually-impaired persons, such as different-sized bills for each denomination; raised or embossed numerals, characters, or braile symbols on the banknotes; electronic bill-reading features and devices; windows in the banknotes; and other such proposals, as is explained more fully in the DETAILED DESCRIPTION.

### BRIEF DESCRIPTION OF THE DRAWINGS

FIG. 1 illustrates two options for truncating (clipping) the corners of U.S. banknotes to make their denominations readable by visually-impaired persons.

1(a) illustrates a $1 banknote with its four corners rounded with a paper die-cutter having four ¼ inch corner radii.

1(b) illustrates a $1 banknote with its four corners clipped by straight angled cuts, each cut having two sides ¼ inch in length.

FIG. 2 illustrates $1, $2, and $5 banknotes with specific corners rounded to define their denominations.

2(a) illustrates a $1 banknote with four corners rounded.

2(b) illustrates a $2 banknote with three corners rounded.

2(c) illustrates a $5 banknote with two corners rounded, with both rounded corners on the same long edge of the note.

FIG. 3 illustrates $10, $20, and $50 banknotes with specific corners rounded to define their denominations.

3(a) illustrates a $10 banknote with two corners rounded, with both rounded corners on the same short edge of the note.

3(b) illustrates a $20 banknote with two opposite corners rounded.

3(c) illustrates a $50 banknote with one corner rounded.

### DETAILED DESCRIPTION OF THE INVENTION

This invention consists of a simple method and system for making U.S. banknotes easily readable by all visually-impaired persons, without any assistance from a sighted person. The proposed method allows standard U.S. banknotes to be printed by the U.S. Bureau of Engraving and Printing exactly as is currently done, except for one simple modification. Each banknote denomination, from $1 through $50, shall have one or more of its corners truncated (herein called “clipped”) by removing a small rounded or straight-cut section from the corner, so that a visually-impaired person can hold the banknote in his/her hands in any orientation and easily distinguish by feel the number and location of its clipped corners, hence the denomination, of each banknote.

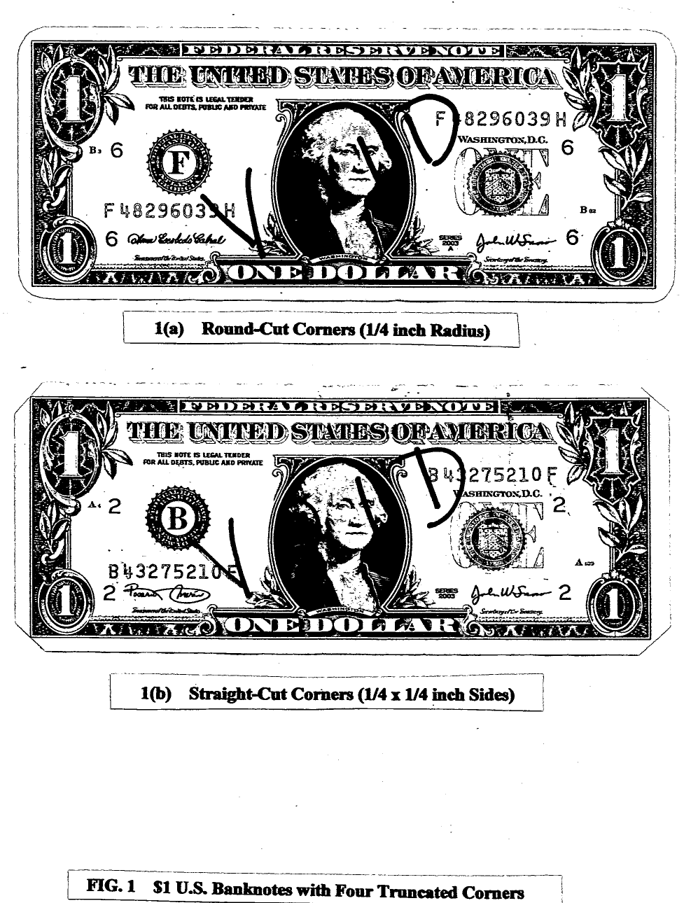

FIG. 1 illustrates $1 banknotes with their four corners clipped by ¼ inch radii round-cuts, 1(a); and straight-cuts having two ¼ inch sides, 1(b). Obviously, other variations of the corner cuts could also be used, such as non-circular curves or unsymmetrical straight cuts. Different round-cut radii or straight-cut side lengths could also be used if testing with visually-impaired persons show them to be better. However, the two variations shown herein are the simplest and preferred alternatives.

In the system disclosed herein, the $1 banknote shall have all four corners clipped; the $2 banknote three corners clipped; the $5 banknote two corners clipped on a long edge of the note; the $10 banknote two corners clipped on a short edge of the note; the $20 banknote two corners clipped on opposite corners of the note; and the $50 banknote one corner clipped. Larger denomination banknotes ($100, $500, etc.) are not normally used by visually-impaired persons in retail trade, and shall have no corners clipped.

Note that the $5, $10, and $20 banknotes all have two, but different, corners clipped. The currency designers will have the option of choosing any one of the two-corner alternatives for each of these three denominations, since all will work equally well in the proposed system.

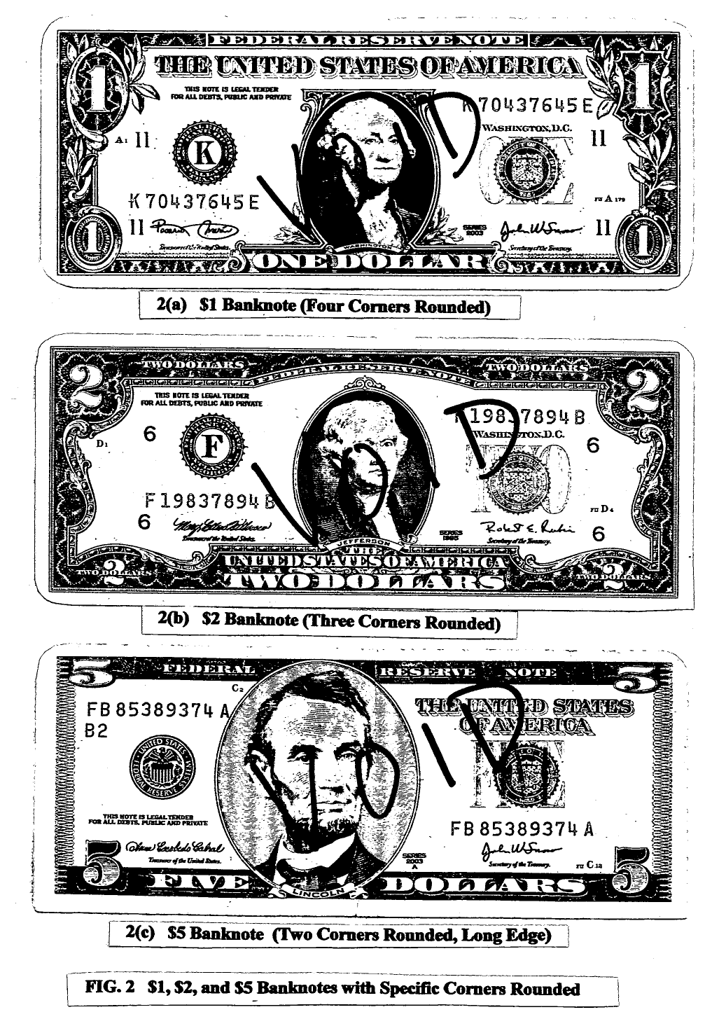

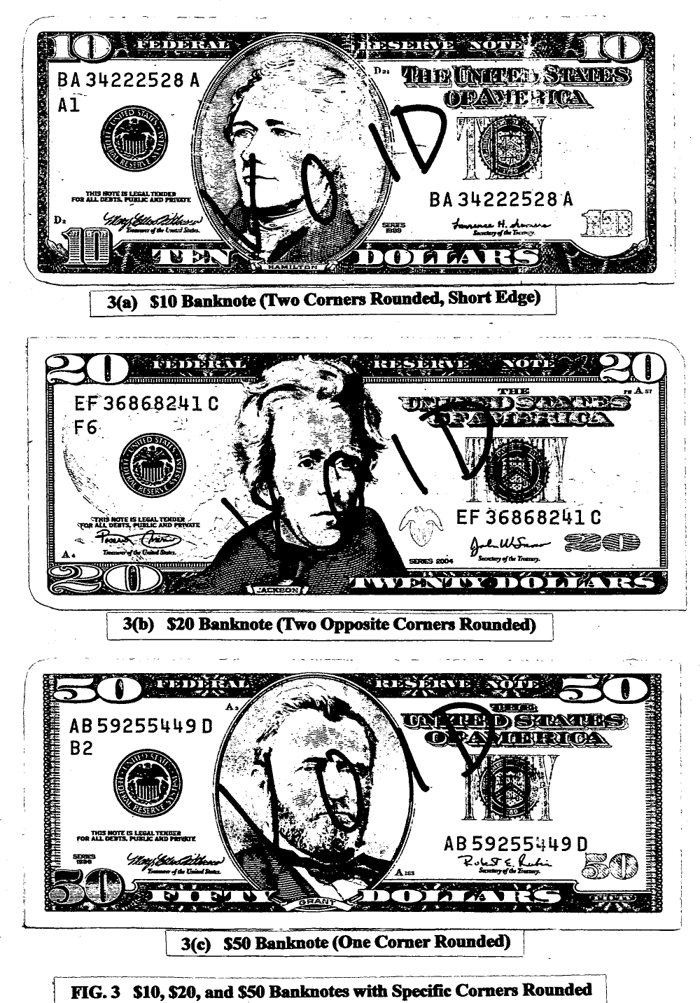

FIGS. 2 and 3 illustrate the method of clipping (in this case by rounding) the corners of $1, $2, $5, $10, $20, and $50 banknotes in the systematic manner described in the previous paragraph.

This progression system has been designed so that a denomination of a banknote cannot be increased by clipping additional corners in order to defraud a visually-impaired person. Any alteration of a banknote by clipping an additional corner would only decrease the value of the banknote. For example, clipping a third corner off of a $5, $10, or $20 banknote would make them feel like a $2 banknote to a visually-impaired person.

This method and system has many advantages over other proposed solutions to the goal of providing a useable currency system to visually-impaired persons.

1. It is simple and requires no training, no knowledge of braille, nor electronic bill-reading devices to be 100% effective for all visually-impaired persons.

2. It requires no changes to the current U.S. banknote printing process, except for a relatively simple modification to the paper die-cutters to produce the clipped corners.

3. None of the sophisticated anti-counterfeiting features recently introduced at great cost into U.S. paper currency will be affected.

4. The $1 banknotes with four clipped corners have been tested and found to work well in existing retail vending machines. Similar success is expected in ATMs and banknote counting machines. Hence, the many millions of such machines now in service throughout the country will not have to be replaced.

5. The invention does not employ raised or embossed characters on the banknotes. Such raised characters on the paper would quickly wear down in normal use, especially when put through machines, and significantly reduce the useful life of the banknote.

6. The new rounded-corner banknotes will be very similar in appearance to our current sharp-cornered banknotes, and thus will be aesthetically attractive as well as highly functional. In fact, the new $1 banknote with its pleasingly rounded four corners will resist becoming “dog-eared” and should be structurally superior and longer-lived than the current $1 banknotes.

In summary, this simple invention will provide foolproof useable currency to all of the millions of visually-impaired U.S. citizens at almost no cost to the U.S. Treasury Department, nor to the owners of the millions of ATM, vending, and bill counting machines now in use in the U.S.

The introduction of the new clipped banknotes will undoubtedly require a transition period when the old plain banknotes and the new clipped banknotes are both in circulation. During this period a visually-impaired person will not be protected by the new banknotes and, in fact, will have to be vigilant to ensure that unscrupulous persons do not clip the corners of an old $1 banknote to make it feel like a higher denomination new banknote. However, when the transition period ends and the old banknotes are no longer valid for trade, there will be little incentive for thieves to hoard them on the off-chance that they could use them to try to defraud a blind vendor. At this time the new clipped banknotes will ensure that visually-impaired shoppers and vendors have a paper currency system that places them on equal footing with the sighted population when engaging in retail trade in America

I claim:

1. A system and method for making U.S. currency banknotes readable by visually-impaired persons; said system and method consisting of truncating, i.e. shortening by cutting off, small rounded or straight-cut sections from specific corners of each denomination banknote, so that a visually-impaired person can hold said banknote in his or her hand in any orientation and detect by feel the number and location of said truncated corners of said banknote, and thereby determine its correct denomination, and
said system and method consisting of truncating the corners of the six lowest-value U.S. banknotes, i.e. banknote denominations of $1, $2, $5, $10, $20, and $50, in a specific sequence which prevents the fraudulent alteration of said banknotes by the truncation of additional corners of a banknote to make it feel like a higher-valued banknote to a visually-impaired person; said specific sequence to be:
$1 denomination, four corners truncated;
$2 denomination, three corners truncated;
$5 denomination, two corners truncated along one long edge of the banknote;
$10 denomination, two corners truncated along one short edge of the banknote;
$20 denomination, two opposite corners of the banknote truncated;
$50 denomination, one corner truncated;
and, alternatively, any of the three two-corner options defined above for the $5, $10, and $20 banknotes can be designated for any of these three specific denominations, at the discretion of the currency designer.
